(19) United States
(12) Patent Application Publication
(10) Pub. No.: US 2003/0205512 A1
(43) Pub. Date: Nov. 6, 2003

(54) External type filter structure for aquarium

(76) Inventor: Chi-Der Chen, Taipei (TW)

Correspondence Address: Keith Kline, PRO-TECHTOR INTERNATIONAL, 20775 Norada Court, Saratoga, CA, 95070-3018, US

(21) Appl. No.: 10/140,528

(22) Filed: May 6, 2002

(51) Int. Cl. A01K 63/04

(52) U.S. Cl. 210/169; 210/416.2; 119/260

(57) ABSTRACT

An external type filter structure for an aquarium includes a box-like body, which is provided with first and second chambers. The first chamber is provided with a bent extraction pump guide tube. The second chamber has a drip case which has a plurality of through holes and a filter sponge disposed at an upper end thereof. A partition plate is disposed between the first and second chambers such that, when the filter is hung on the aquarium, the extraction pump guide tube pumps the dirty water into the first chamber. The water overflowing from the first chamber flows via an upper end of the partition plate into the second chamber for filtering via a filter mesh and the drip case to thereby enhance the filtering effect and permit culturing of nitrogenous bacteria and decomposition of impurities such as ammonia in the water.

### BACKGROUND OF THE INVENTION

(a) Field of the Invention

The present invention relates generally to an external type filter structure for an aquarium, more particularly to a filter structure that has a good filtering effect and that can decompose impurities in the water.

(b) Description of the Prior Art

With reference to FIGS. 1 and 2, a conventional external type filter for an aquarium generally includes a case 1, in which an extraction pump guide tube 11 and a filter mesh 12 are disposed. The pump guide tube 11 pumps water into the case 1, and the water is filtered via the filter mesh 12. As such a conventional filter involves a very simple filtering procedure, and there is no partition between the pump guide tube 11 and the filtering zone, the filtering of impurity deposit is not effective, and air cannot be sufficiently absorbed, thereby affecting adversely the quality of the filtered water.

### SUMMARY OF THE INVENTION

Therefore, the main object of the present invention is to provide an external type filter structure for an aquarium which can enhance the effect of filtering water in the aquarium and which can decompose impurities in the water.

The aforesaid filter structure includes a box-like body. A partition plate is disposed in the body to partition first and second chambers. The first chamber is provided with a bent extraction pump guide tube for passage of water into the first chamber. When the first chamber is full, the overflowing water flows into the second chamber. Hence, the filtering effect is enhanced.

### BRIEF DESCRIPTION OF THE DRAWINGS

The foregoing and other features and advantages of the present invention will be more clearly understood from the following detailed description and the accompanying drawings, in which,

FIG. 1 is a schematic perspective view of a conventional filter;

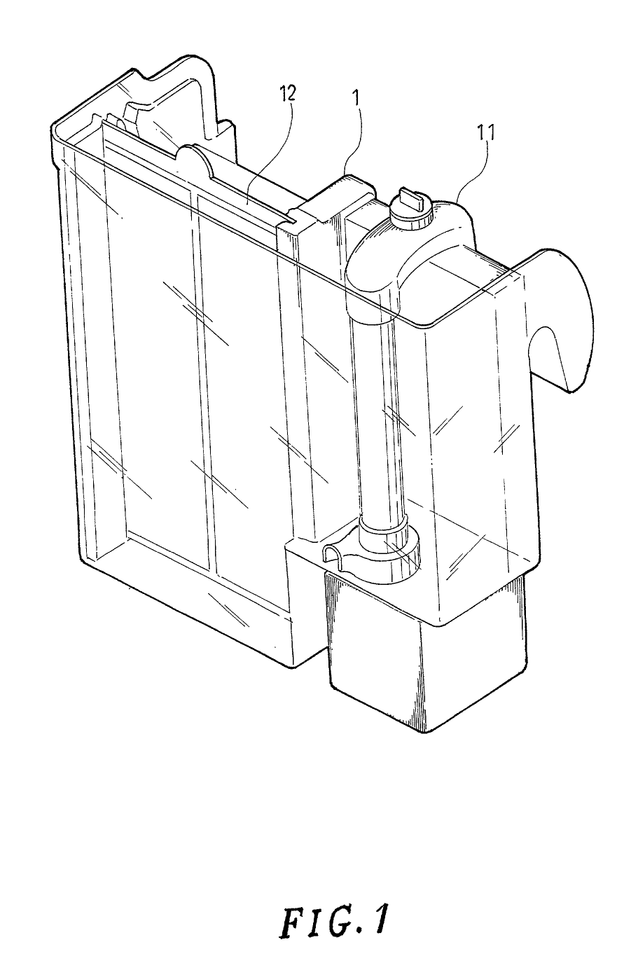

FIG. 2 is a schematic sectional view of the conventional filter, showing the operation thereof;

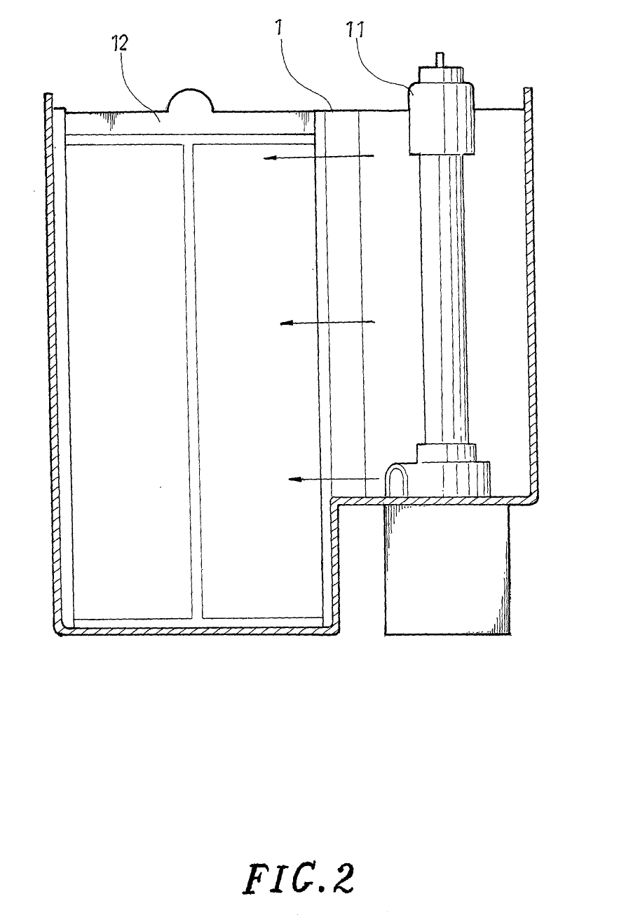

FIG. 3 is a schematic exploded perspective view of the present invention;

FIG. 4 is a schematic exploded perspective view of the present invention; and

FIG. 5 is a schematic sectional view of the present invention, showing the operation thereof.

### DETAILED DESCRIPTION OF THE PREFERRED EMBODIMENT

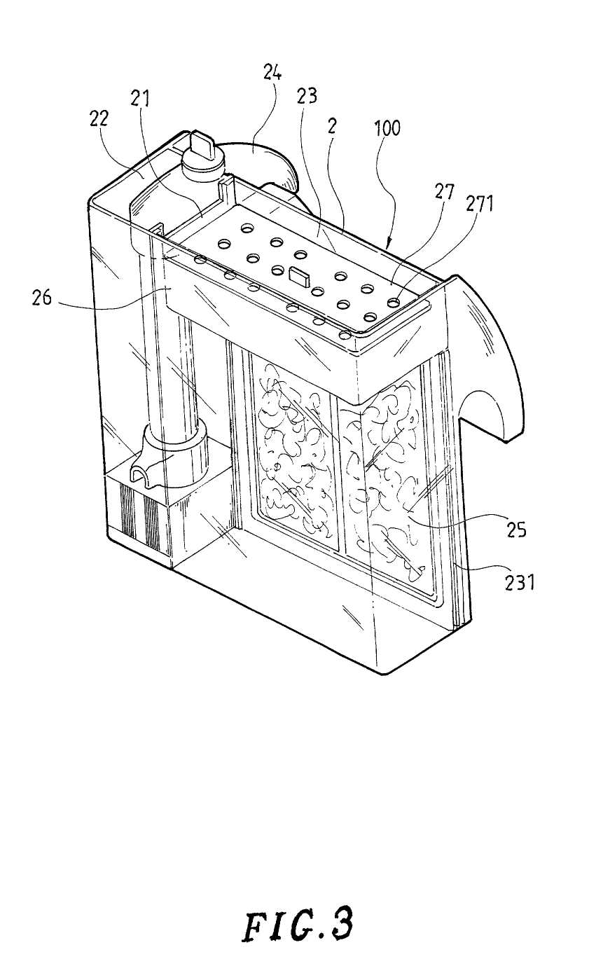

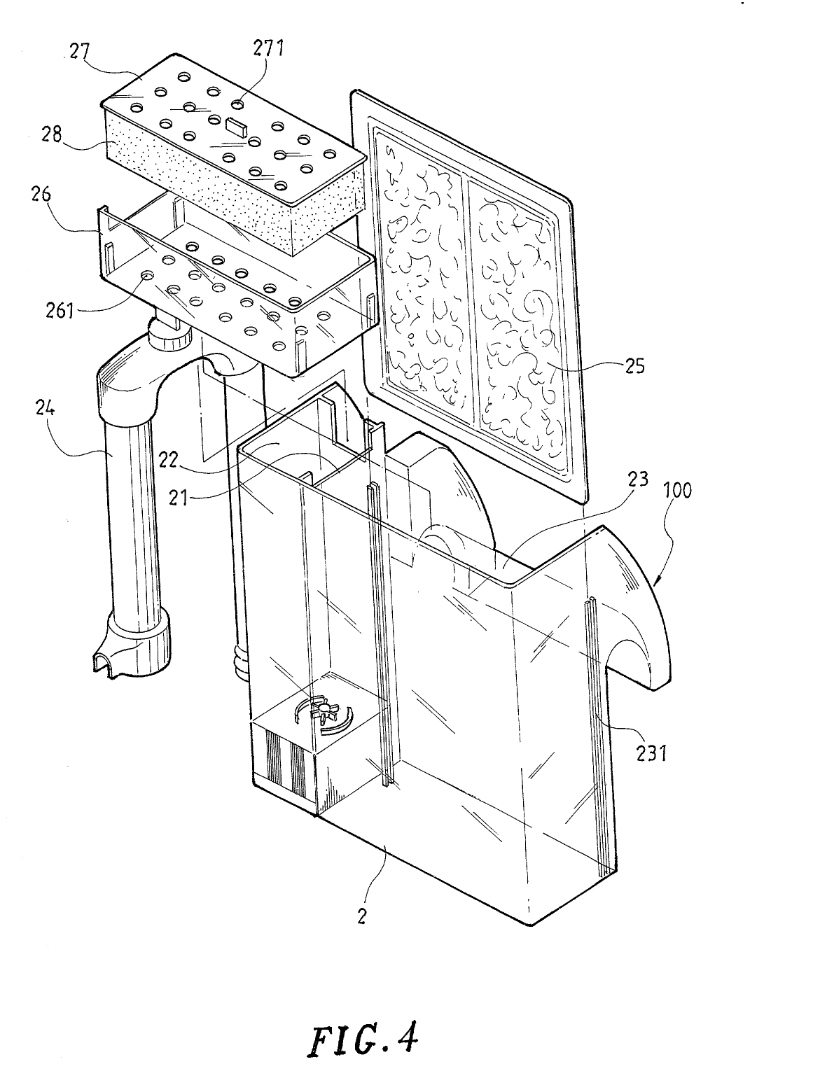

With reference to FIGS. 3 and 4, the present invention is essentially provided with a box-like body 2. The box-like body 2 is divided by a partition plate 21 into a first chamber 22 and a second chamber 23. The first chamber 22 is provided with a bent ex traction pump guide tube 24. The second chamber 23 is provided with slide rails 231 on lateral edges thereof for mounting of a filter mesh 25. An upper end of the second chamber 23 is provided with drip case 26. The bottom portion of the drip case 26 and a cover 27 are provided with a plurality of through holes 261, 271. A filter sponge 28 is disposed inside the drip case 26.

Assembly of the aforesaid structural elements constitutes an external type filter 100 for hanging on the aquarium. The extraction pump guide tube 24 pumps water into the first chamber 22. When the first chamber 22 is full, the overflowing water will flow into the second chamber 23 so that the water flows through the filter mesh 25 and the drip case 26, thereby filtering the water sufficiently to remove the impurities in the water, inducing air, and culturing nitrogenous bacteria and decomposing impurities such as ammonia in the water.

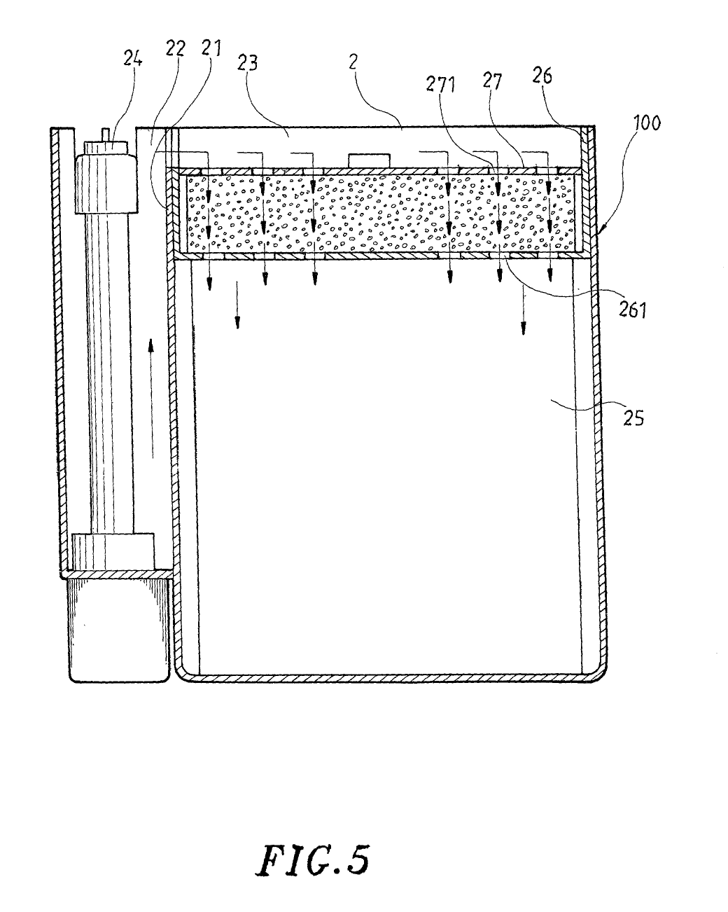

Referring to FIGS. 3 and 5, in actual use, the pump guide tube 24 is sued to pump water into the first chamber 22. When the first chamber 22 is full, the water will flow via the upper end of the partition plate 21 into the second chamber 23 so that the water drips slowly through the through holes 261, 271 in the drip case 26 and the cover 27 thereof into the second chamber 23. Thus, the water is filtered by the sponge 28 in the drip case 26 and the filter mesh 25. Due to the arrangement of the drip case 26, air can be sufficiently absorbed, nitrogenous bacteria can be cultured, and impurities such as ammonia in the water can be decomposed, thereby enhancing the filtering effect.

Although the present invention has been illustrated and described with reference to the preferred embodiment thereof, it should be understood that it is in no way limited to the details of such embodiment but is capable of numerous modifications within the scope of the appended claims.

What is claimed is:

1. An external type filter structure, comprising a box-like body, a bent water pump guide tube, and a filter mesh, said pump guide tube pumping dirty water into said body for filtering via said filter mesh, wherein:
said body is divided by a partition plate into first and second chambers, said pump guide tube being disposed in said first chamber, a case and a cover being disposed at an upper end of said second chamber, said case and said cover being provided with a plurality of through holes, a filter sponge being disposed in said case to form a drip case, said pump guide tube pumping water into said first chamber, water overflowing from said first chamber flowing via an upper end of said partition plate into said second chamber so that the dirty water is filtered via said drip case to thereby enhance the filtering effect and permit decomposition impurities in the water.
